(19) United States
(12) Patent Application Publication
(10) Pub. No.: US 2026/0031248 A1
(43) Pub. Date: Jan. 29, 2026

(54) CARRYING APPARATUS FOR MULTIPLE RADIOACTIVE AMPOULES

(71) Applicant: ECZACIBASI MONROL NÜKLEER ÜRÜNLER SANAYI VE TICARET ANONIM SIRKETI, Gebze/Kocaeli (TR)

(72) Inventors: Barkin RAKICIOGLU, Gebze/Kocaeli (TR); Ismet Can KOLTUK, Gebze/Kocaeli (TR); Mehmet Tunç TUNÇEL, Gebze/Kocaeli (TR)

(21) Appl. No.: 19/144,067

(22) PCT Filed: Jul. 18, 2023
(86) PCT No.: PCT/TR2023/050685

§ 371 Date: Jun. 27, 2025

(30) Foreign Application Priority Data
Dec. 27, 2022 (TR) 2022020644

(51) Int. Cl. G21F 5/015; G21F 1/08

(52) U.S. Cl. CPC G21F 5/015; G21F 1/08

(57) ABSTRACT

A carrying apparatus for multiple radioactive ampoules enables a plurality of irradiated radioactive substance ampoules to be simultaneously transported in a protected manner inside a type B radioactive substance transport container. The carrying apparatus for multiple radioactive ampoules includes at least two, preferably four, ampoule holders (4). The ampoule holders (4) are each positioned at an equal distance from the axis of symmetry of the transport container. In this way, it is ensured that the ampoules are transported in a safe manner in terms of radioactivity.

### SUBJECT OF THE INVENTION

The invention relates to a carrying apparatus for multiple radioactive ampoules, which enables a plurality of irradiated radioactive substance ampoules to be simultaneously transported in a protected manner inside a type B radioactive substance transport container.

### STATE OF THE ART

Today, along with the increasing use of the radiation sources in numerous fields such as medicine, industry, agriculture, research, and education, the need for safe transport of the radioactive substances in a short time from their places of manufacture to various places of use has also increased. Various transport packages, varying according to the safe radioactivity levels, are used for transporting the radioactive substances.

Type B packages are used for transporting the materials with high level of radioactivity, such as the fuels spent in the nuclear plants. Type B packages provide high level of protection against radiation and the size of these packages may vary from small containers to big containers with a capacity of over 100 tons. These packages are designed in such a way to provide protection even in the case of an accident. For example, type B(U)/B(M) packages are used for transporting the substances with high radioactive activity such as anticancer drugs, gamma radiator sources and industrial radiography sources.

The radioactivity values that are safe to transport varies according to the dimensions of the type B transport containers. The irradiated radioactive substances are transported by way of being placed into a carrying apparatus inside the high-cost type B containers. According to the state of the art, it is possible to transport only one irradiated substance ampoule inside the carrying apparatus in a type B radioactive substance transport container. As a result, more than one type B container is used in order to transport more than ampoule, this constituting a drawback in terms of time and cost.

Because of the inability to transport a plurality of radioactive ampoules inside a type B radioactive substance transport container according to the state of the art, there exists a need to develop the carrying apparatus enabling a plurality of radioactive ampoules simultaneously in a protected manner.

### OBJECT OF THE INVENTION

An object of the invention is to enable a plurality of irradiated radioactive ampoules to be transported simultaneously and in a safe manner in terms of radioactivity inside a type B radioactive substance transport container. The carrying apparatus according to the invention comprises a plurality of ampoule holders, and, owing to said holders each being positioned at an equal distance from the axis of symmetry of the transport container, it is made possible to transport the ampoules in a safe manner in terms of radioactivity.

Owing to the carrying apparatus for multiple radioactive ampoules according to the invention, more than one irradiated radioactive substance ampoule may be transported simultaneously and thus, time may be saved and a plurality of ampoules may be transported to the necessary destinations in a short time. Further, since it will be possible to transport e.g. four ampoules simultaneously owing to the invention, four irradiated radioactive substance ampoules may be transported at the transport cost of a single ampoule according to the state of art.

Another object of the invention is to enable a plurality of ampoules to be transported in a protected manner inside a type B radioactive substance transport container. In order to ensure that the ampoules are not damaged during the transport, the perimeter of the carrying apparatus is supported with an o-ring and the ampoules are thus secured.

Moreover, a hole is made in the lower base of the carrying apparatus to thereby obtain a more flexible structure and enable the ampoules to be gripped better after the o-ring is added.

### DESCRIPTION OF THE FIGURES

FIG. 1: A frontal view (A) and a sectional view (B) of the carrying apparatus for multiple radioactive ampoules

FIG. 2: A top view (A) and a bottom view (B) of the carrying apparatus for multiple radioactive ampoules

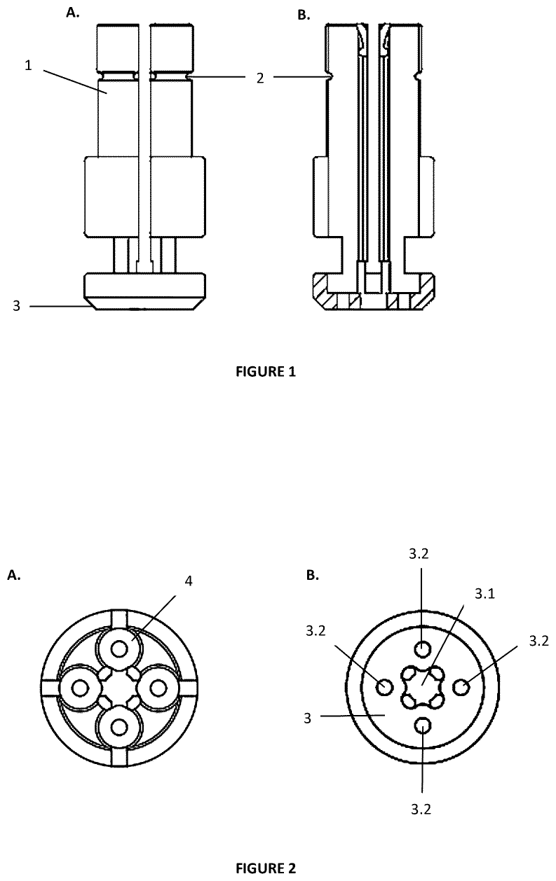

### DESCRIPTION OF THE REFERENCE NUMERALS IN THE FIGURES

1: Body
2: O-ring slot
3: Lower base
3.1: Opening
3.2: Hole
4: Ampoule holder

### DETAILED DESCRIPTION OF THE INVENTION

The invention describes a carrying apparatus for multiple radioactive ampoules, which enables a plurality of irradiated radioactive substance ampoules to be simultaneously transported in a protected manner inside a type B radioactive substance transport container.

The carrying apparatus for multiple radioactive ampoules according to the invention comprises at least two, preferably four, radioactive ampoule holders (4). Said ampoule holders (4) are each positioned at an equal distance from the axis of symmetry of the transport container. In this way, it is made possible to transport the ampoules in a safe manner in terms of radioactivity.

The type B containers, in which the radioactive ampoules are transported, have a cylindrical form. Thus, the carrying apparatus placed into said type B containers accordingly have a cylindrical form. With a view to ensure the safety in terms of radioactivity, the carrying apparatus placed into the container are positioned at the center of the container in such a way that they are equidistant from the outer surface of the container. The ampoules are each positioned such that they will be equidistant from the axis of symmetry of the transport container, hence from the axis of symmetry of the carrying apparatus, in order to ensure safety in terms of radioactivity.

From the perspective of radiation safety, in an example of the invention, the safe value of radioactivity that can be transported inside a type B titanium steel container with a weight of 65 kg at one time is maximum 3.43E+02 Terabecquerels (TBq) (343 TBq) for a substance containing the isotope Lutetium-177. This value is valid only for the transport container in the mentioned example and different values may apply for other type B containers.

The number of the transported ampoules and of the ampoule holders may be increased provided that the radioactivity value for the specific substance being transported remains within the safe range. In an embodiment of the invention, at least two, preferably four, ampoule holders (4) are present inside the multiple-ampoule carrying apparatus in order to enable the safe transport of Lutetium 177 (Lu-177) (FIG. 2).

The carrying apparatus for multiple ampoules according to the invention comprises at least one o-ring slot (2) on the body (1) so that a plurality of ampoules may be secured to enable the transport of the same in a protected manner. In a preferred embodiment of the invention, one o-ring slot (2) is available and the ampoules are secured as a result of the pressure applied by an o-ring that is added in said slot.

The carrying apparatus for multiple ampoules comprises an opening (3.1) at the center of the lower base (3) and, owing to this opening, the apparatus is provided with a flexible structure. In this way, the ampoules are enabled to be gripped better after the o-ring is added.

On the lower base (3) of the carrying apparatus for multiple ampoules, the holes (3.2), which are provided in a number equal to the number of ampoule holders (4), are disposed such that they will be positioned below each corresponding ampoule holder (4). These holes (3.2) enable the ampoules to be removed easily from the holders.

1. A carrying apparatus for radioactive ampoules comprising at least two radioactive ampoule holders positioned at an equal distance from the axis of symmetry.

2. The carrying apparatus for radioactive ampoules according to claim 1 wherein the carrying apparatus comprises four radioactive ampoule holders positioned at an equal distance from the axis of symmetry.

3. The carrying apparatus for radioactive ampoules according to claim 1 further comprising at least one o-ring slot on the body.

4. The carrying apparatus for radioactive ampoules according to claim 1 comprising one o-ring slot on the body.

5. The carrying apparatus for radioactive ampoules according to claim 1 further comprising an opening at the center of the lower base so that said carrying apparatus is provided with a flexible structure.

6. The carrying apparatus for radioactive ampoules according to claim 1 further comprising holes on the lower base of said carrying apparatus, said holes being disposed such that they are positioned below each corresponding ampoule holder.

7. The carrying apparatus for radioactive ampoules according to claim 6 wherein said holes are present in a number that is equal to the number of ampoule holders.

8. The carrying apparatus for radioactive ampoules according to claim 1 in combination with at least one radioactive ampoule located within one of the ampoule holders wherein a substance inside the radioactive ampoule is Lutetium-177.

9. The carrying apparatus for radioactive ampoules according to claim 1 wherein the carrying apparatus is configured to be used inside a type B radioactive substance transport container.

10. The carrying apparatus for radioactive ampoules according to claim 9 wherein said type B radioactive substance transport container is a type B titanium steel container with a weight of 65 kg.

11. The carrying apparatus for radioactive ampoules according to claim 9 wherein the safe value of radioactivity that can be transported inside said type B radioactive substance transport container at one time is a maximum of 3.43E+02 Terabecquerel (TBq) for a substance containing isotope Lutetium-177.

12. A carrying apparatus for radioactive ampoules for use inside a type B radioactive substance transport container comprising at least two ampoule holders, configured equidistantly from the axis of symmetry of the transport container.

13. The carrying apparatus for radioactive ampoules according to claim 12 wherein said type B radioactive substance transport container is a type B titanium steel container with a weight of 65 kg and the safe value of radioactivity that can be transported inside said transport container at one time is a maximum of 3.43E+02 TBq for a substance containing isotope Lutetium-177.
